(19) United States
(12) Patent Application Publication
(10) Pub. No.: US 2007/0043709 A1
(43) Pub. Date: Feb. 22, 2007

(54) Searching for information about assets

(76) Inventor: Steven Strassmann, Brookline, MA (US)

Correspondence Address: FISH & RICHARDSON PC, P.O. BOX 1022, MINNEAPOLIS, MN, 55440-1022, US

(21) Appl. No.: 11/400,128

(22) Filed: Apr. 7, 2006

Related U.S. Application Data
(60) Provisional application No. 60/708,448, filed on Aug. 16, 2005.

(51) Int. Cl. G06F 17/30

(52) U.S. Cl. 707/3

(57) ABSTRACT

A method includes receiving an electronic query of a user directed to obtaining items of information belonging to one or more predefined categories and that relate to an interest of the user in a specified product, searching in multiple locations, and presenting to the user essentially only items of information that relate to the interest of the user and that belong to the categories, the items not being limited to a price and a source for the product and not being limited to items that have been pre-arranged for presentation to the user in reply to an online query that refers to the product.

### RELATED APPLICATION

This application claims priority from co-pending provisional U.S. Application Ser. No. 60/708,448, filed Aug. 16, 2005.

### TECHNICAL FIELD

This description relates to data search and storage, and more particularly to searching for or storing information about assets using an inference-based process.

### BACKGROUND

Individuals purchase or acquire products, and often need a mechanism to keep track of the products. In addition, products often require service, maintenance, or accessories, which an individual may prefer to keep track of in one place.

### SUMMARY

In one aspect, in general, the invention features a method comprising receiving an electronic query of a user directed to obtaining items of information belonging to one or more predefined categories and that relate to an interest of the user in a specified product, searching in a plurality of locations, and presenting to the user essentially only items of information that relate to the interest of the user and that belong to the categories, the items not being limited to a price and a source for the product and not being limited to items that have been pre-arranged for presentation to the user in reply to an online query that refers to the product.

Implementations may include one or more of the following features: The plurality of locations includes a database. The plurality of locations includes a web site. The plurality of locations includes two locations on the internet, the two locations on the internet being owned by different entities. The interest of the user in the product comprises an ownership interest. One of the categories comprises information relevant to maintaining the product. One of the categories comprises product manuals. One of the categories comprises web sites. The web sites belong to the product manufacturer. The method includes the further step of storing the items of information. The items of information are stored in a location under the user's control. The method includes the further steps of receiving other information about the product from the user, and associating the items of information with the other information. The method includes the further steps of receiving other information about the product from a retailer, and associating the items of information with the other information. The other information comprises a serial number. The other information comprises a purchase date. The other information comprises a proof of purchase.

In another aspect, in general, the invention features a method comprising, at the request of a user who has a interest in a product, electronically searching for first information that is associated with the product and is relevant to the property interest, receiving results of the search, at least two results being received from different sources, receiving additional information from the user about the product; associating the additional information with the first information; and storing the additional information in a location controlled by the user.

Implementations may include one or more of the following features: The interest is a property interest. The step of electronic searching is performed on the internet. The first information is relevant to maintaining the product. The additional information comprises a serial number.

The details of one or more embodiments of the invention are set forth in the accompanying drawings and the description below. Some of the examples address aspects of these consumer needs. Additional features of the invention will be apparent from the description and drawings, and from the claims.

### DESCRIPTION OF DRAWINGS

FIG. 1 is a block diagram.

FIGS. 2, 3A, 3B, and 3C are example screen shots.

FIG. 4 is a block diagram.

FIG. 5 is a flowchart.

FIGS. 6-7 are block diagrams.

FIG. 8 is a flowchart.

FIG. 9 is a block diagram.

FIG. 10 is a flowchart.

FIG. 11 is a block diagram.

FIG. 12 is a flowchart.

FIG. 13 is a block diagram.

### DETAILED DESCRIPTION

The remainder of this description will refer throughout to a series of example systems. In these examples, a system is described by which a user may keep track of items he or she has purchased. Consider a user who owns or is considering purchase of some new product. The term “product” includes, by way of a few examples, (but is not limited to) a tool, device, electronic gadget, appliance, or automobile. In some examples, these products are durable, so that owners tend to need to refer to manuals or require occasional repair or maintenance. In some examples, these products are standardized under a model name or number, so that they can be referred to readily and consistently. These examples are for illustrative purposes only and are not intended to limit the claimed invention.

### User Interface

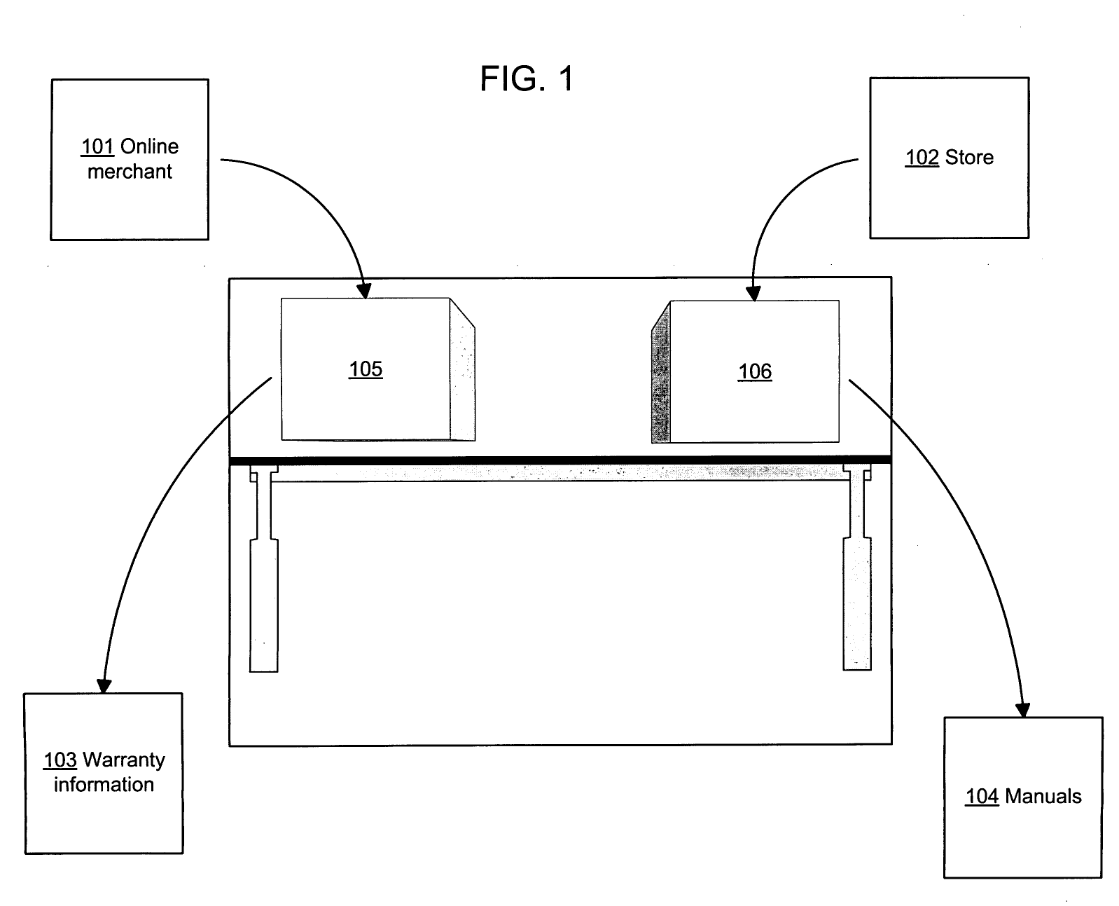

FIG. 1 illustrates a scenario in which an individual has purchased two items 105 and 106. The products were purchased at an online merchant 101 and a traditional store 102, respectively. Each of the items has warranty information 103 and manuals 104. The examples described below provide a method for keeping track, in a centralized location, of a person's products and information necessary to maintain those products, among other things. This information is tracked through a web interface.

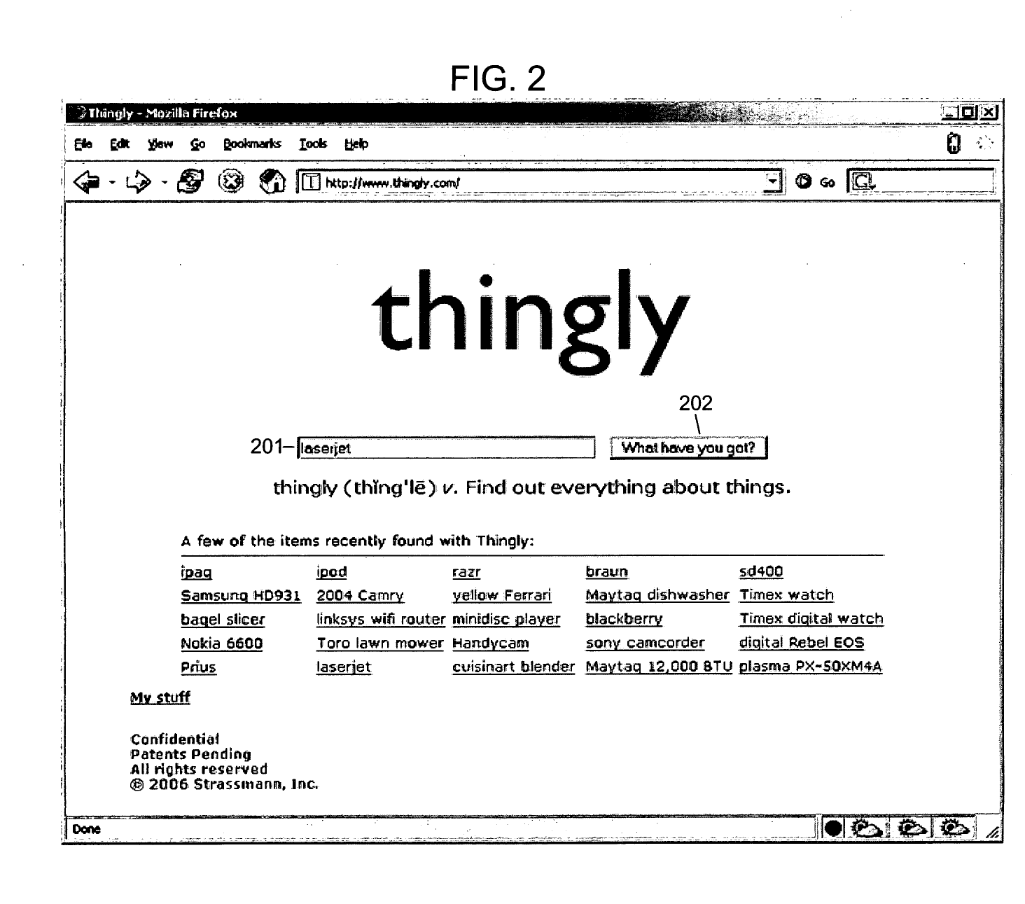

As depicted in FIG. 2, some embodiments are accessed through a search page. The search page has an input box 201 for entry of search terms and a submit button 202 for initiating the search. The user types the name of a product into the input box 201 and clicks on the submit button 202. Thus, for instance, if a user types “Maytag MDB6650A,” an example system searches a database or consults an internet search engine for all information that may be relevant to that product.

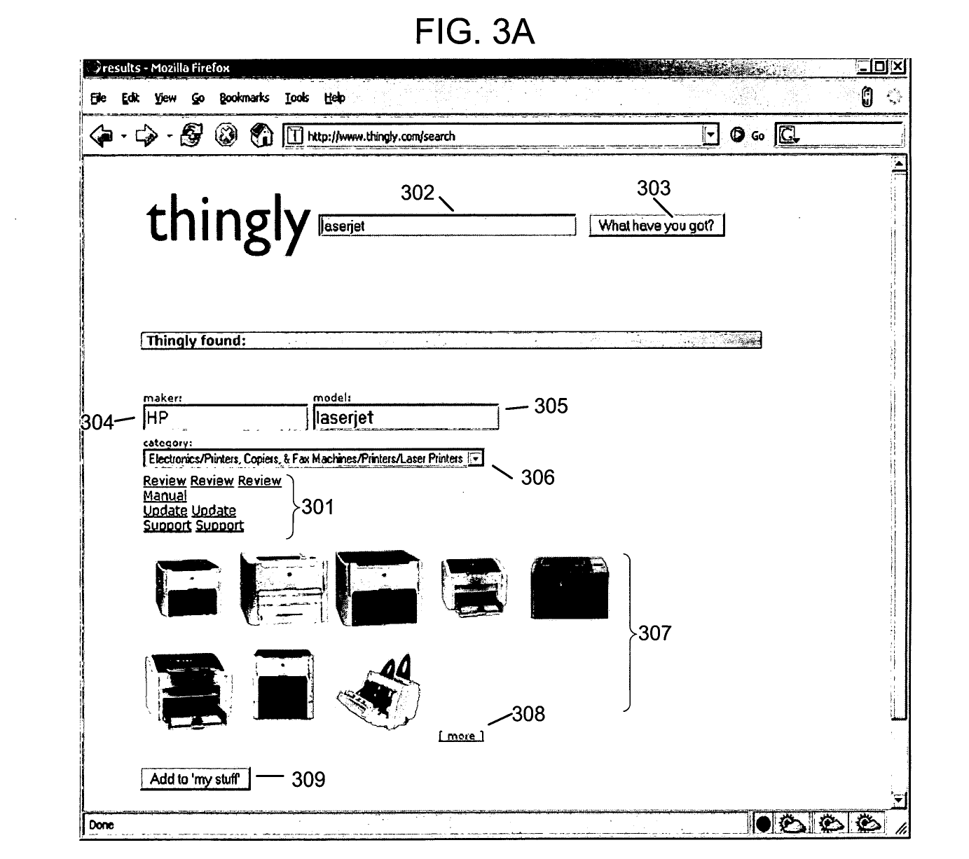

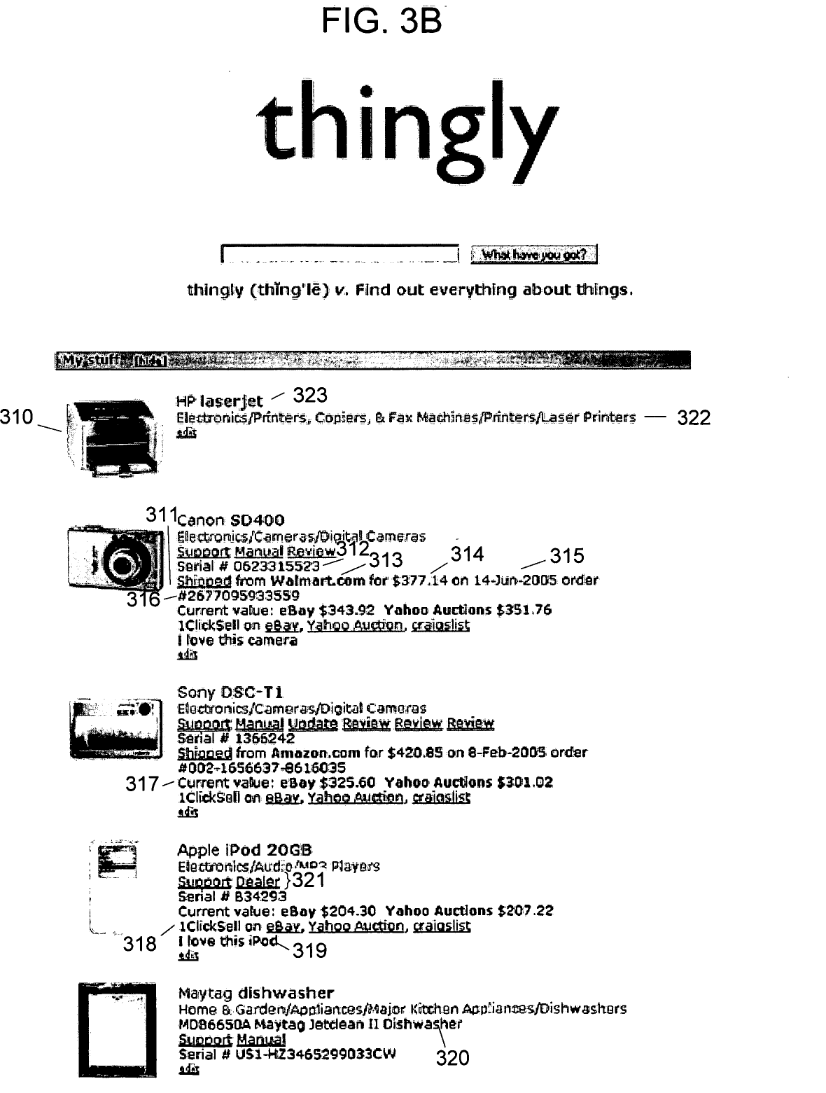

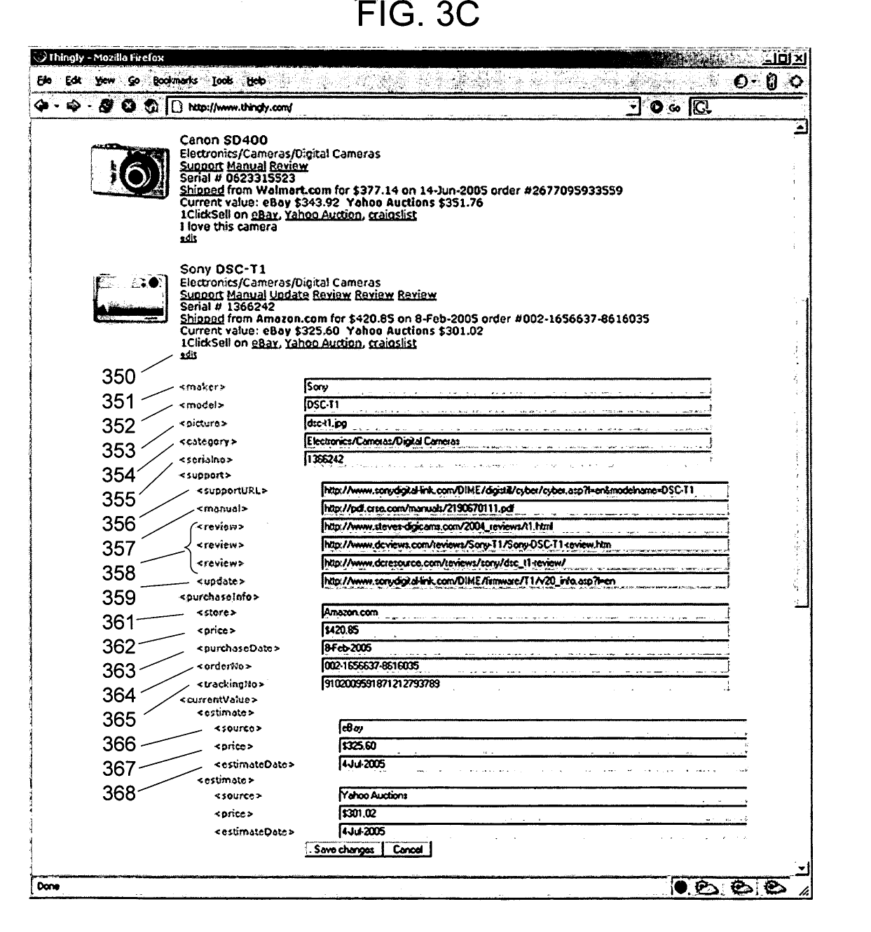

FIG. 3A depicts a web page displaying the result of the search. In some examples, the display includes a product description and support section 301. Some or all of the following information is presented in the product description and support section 301:

| Data | Example |
|---|---|
| Manufacturer | Maytag |
| Model name | Jetclean II Dishwasher |
| Model number | MDB6650A |
| Category | Home & Home & Garden/Appliances/Major |
| | Kitchen Appliances/Dishwashers |
| Home page | http://www.maytag.com |
| Catalog description | <text downloaded from Maytag web site> |
| Product brochures | <Adobe Acrobat files downloaded from Maytag |
| | web site> |
| Product | <photographs downloaded from Maytag web site> |
| photographs | |
| Manuals | <downloadable Owner's Manual, Installation |
| | Manual, and Repair Manual> |
| Updates | <Links to product software updates, if any> |
| Authorized national | <Links to authorized Maytag dealers> |
| dealers | |
| Local dealers and | <Links to local Maytag dealers> |
| repair shops | |
| Sources for spare | <Links to web sites or stores which sell parts for |
| parts, upgrades, or | your Maytag dishwasher> |
| accessories | |
| Support web site | http://www.maytag.com/support |
| Support phone | 800-4MAYTAG |
| number | |
| User groups | <Link to Maytag discussion forum> |
| Reviews | <Links to reviews of your Maytag dishwasher> |
| Known flaws, | <Links to recall information for your Maytag |
| limitations, or | dishwasher> |
| problems | |

In the example depicted in FIG. 3A, a user enters a product name, model, or some other information identifying a product in search field 302. The user then presses the “return” key or clicks the “what have you got?” button 303. The system responds by determining the manufacturer and model name, using the techniques described in more detail below. The system inserts this information in the maker field 304 and the model field 305. If the system has incorrectly determined the maker or manufacturer, the user, in some examples, can change the information in the maker field 304 and the model field 305 and re-conduct the search (for example, by pressing the “return” key).

The system also determines what category of product has been searched for, and fills this information in the popup menu 306.

Sometimes, the system will determine that more than one category of product is responsive to the search. For example, if the user searches for “IBM,” the system might find products in the “laptop” category as well as products in the “typewriter” category. The user can select a category from the popup menu 306. This action causes the system to only display products in the given category. In some examples, the popup menu 306 includes a category representing “all products.”Images representing the products found by the system are displayed in the image display area 307. The images displayed in this area are, in some examples, limited to the products in the category set by the popup menu 306, manufactured by the maker set in the maker field 304, with a model name matching the setting of the model name field 305.

If there are more found products than can be displayed in the image display area 307, the system, in some examples, displays a “more” button 308. If the user clicks this button, in some examples, the system removes the existing images from the image display area 307, and in their place, displays images representing additional products. In other examples, the system displays a new page with a larger area dedicated to displaying images.

In some instances, the model name displayed in the model field 305 represents a family of products. In some examples, the images displayed in the image display area 307 represent specific models within the product family. For example, in the depicted example, the user has searched for “laserjet” in the search field 302, and the system delivered a result with a maker field 304 reading “HP,” and the model field 305 reading “laserjet.” Because there are a number of different models of LaserJets, various models appeared in the image display area 307.

If the user owns a LaserJet, or is otherwise interested in keeping track of information about LaserJets, he or she clicks, in some examples, on the “Add to my stuff” button 309. Alternatively, the user may know that he or she owns, or is interested in, a specific model of LaserJet. In that case, the user clicks on the specific model in the image display area 307. A new page is displayed that, in some examples, looks identical to the depiction in FIG. 3, except that the model field 305 contains the specific model number, and the image display area 307 contains only images of that particular model of LaserJet. In some examples, the user then clicks the “Add to my stuff” button 309.

In some examples, after the user clicks the “Add to my stuff” button 309, the user is taken to the screen depicted in FIG. 3B. The user may also access this screen directly whenever the user wishes to view a list of items he or she is tracking.

A list of all items the user is tracking appears on the page in the example depicted by FIG. 3B. An image 310 of each item is shown. The image 310 may be either derived from the internet, or may be supplied by the user (e.g., a digital photograph of the user's actual product). The manufacturer and model number 323 are listed, along with the category 322. This information may come from the system itself (as described in more detail below), or may be specified by the user.

In some examples, additional information is displayed about the user's particular product. For example, the system depicted in FIG. 3B displays the product serial number. 312. The depicted example also includes information about the item's shipment information, including the retailer 313, the price 314, the shipment date 315, an order number 316, and a link to the retailer's web site 311.

The depicted example includes links 318 to allow a user to sell the product through various online retailers. In some examples, the link would take a user to a page where certain details of the sale were already automatically filled in, e.g., the product name and model number.

The depicted example also includes information about the current value 317, as determined from one or more online retailers. The example also includes user-supplied comments 319. The depicted example also displays a manufacturer-specific name and part number 320.

FIG. 3C shows a further example of a page listing the items a user is tracking. When the user clicks the edit button 350, additional fields appear that permit the user to fill in information about a product. The depicted example permits a user to edit the product's maker 351 or model 352; to add or change an associated picture 353; to edit the assigned category 354; to enter a serial number 355; to add support information including a URL for the manufacturer's support page 356, the product manual 357, product reviews 358, product updates 359; to add information about the store from which the product was purchased 361 and the purchase price 362, date 363, order number 364, and tracking number 365; and to add information about the product's current value such as a price estimate 367 together with the source of the estimate 366 and the date on which the estimate owas obtained 368.

In some examples, some or all of this information, or additional information, is obtained automatically by the system from external sources.

### Implementation

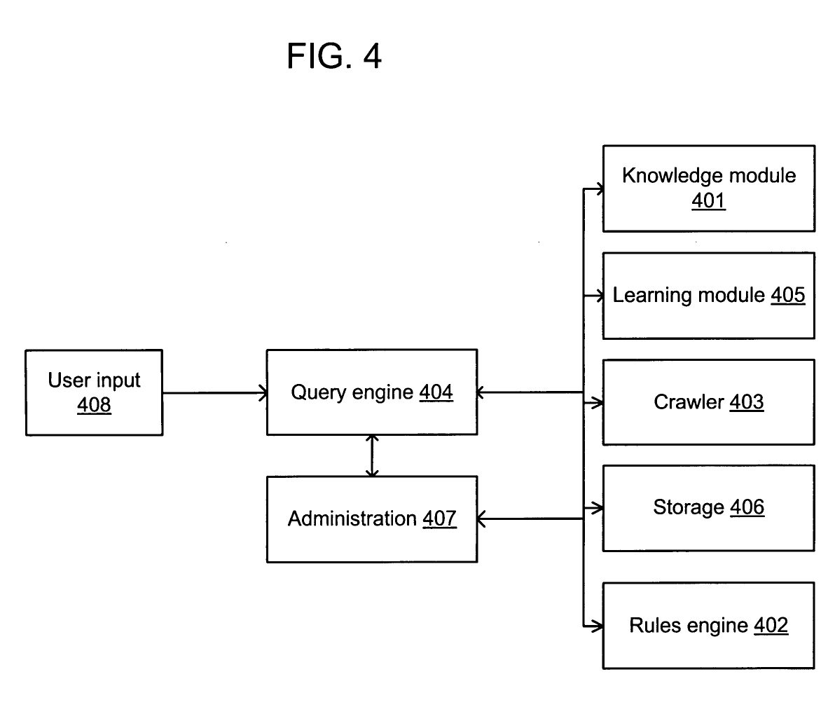

With reference to FIG. 4, some embodiments include seven modules: a) the knowledge module 401; b) the rule engine 402; c) the crawler 403; d) the query engine 404; e) the learning module 405; f) storage 406; and g) administration 407.

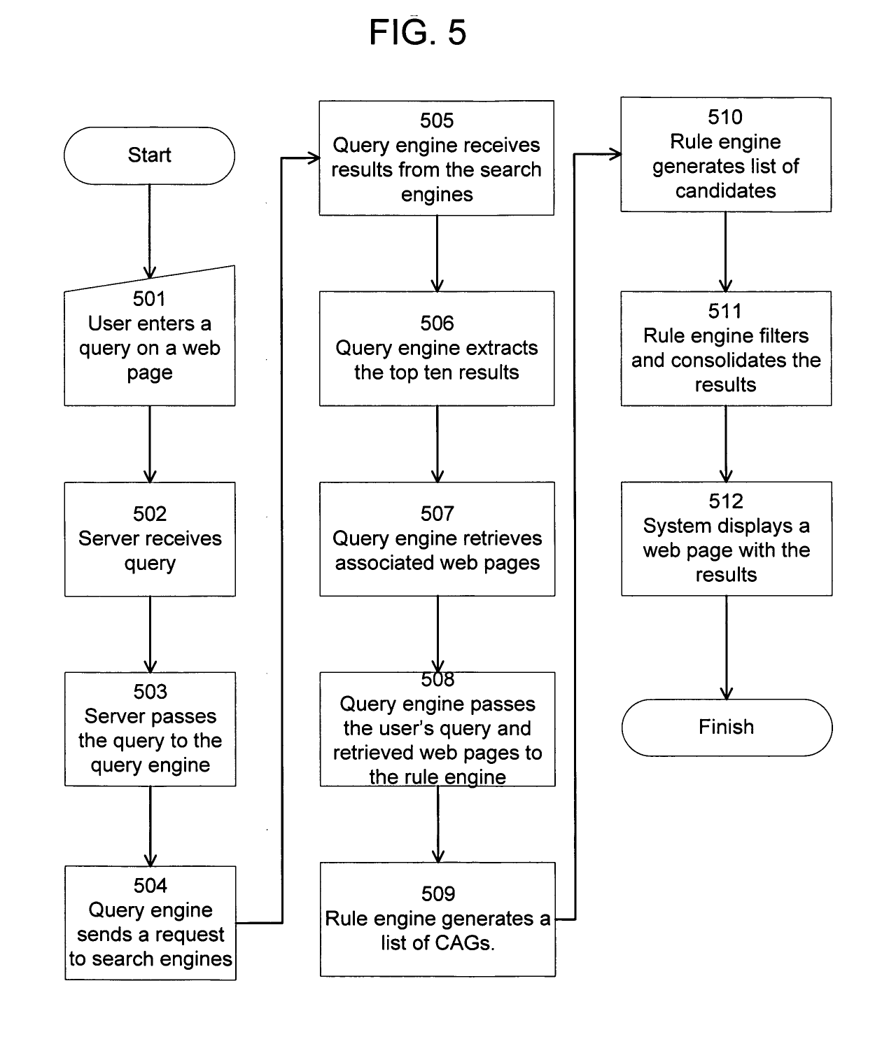

Some example embodiments operate as described in FIG. 5. In step 501, the user enters a query on a web page. The query is received on a server (step 502). The server passes the query to the query engine 404 (step 503). The query engine sends a request to ten search engines, potentially specialized search engines such as www.froogle.com or websearch.alexa.com (step 504). (In other examples, any number of search engines may be used.) In step 505, the query engine 404 receives results from the search engines, and, in step 506, extracts the top ten results from each of the ten search engines (for a total of 100 results). (In other examples, any number of results can be extracted from some or all of the engines; or no results may be extracted.) In step 507, the query engine 404 retrieves the web pages associated with these 100 results.

In step 508, the query engine 404 passes the user's query and the 100 web pages to the rule engine 402. In step 509, as more fully described below, the rule engine 402 generates a list of Core Attribute Guesses (CAGs). A CAG is a data structure representing a likely manufacturer, category, and/or product name relating to the search phrase. The rule engine 402 creates this list by referring to data contained in the knowledge model 401. In step 510, as more fully laid out below, the list of CAGs is fed back into the rule engine 402 to generate a list of “candidates,” which is a CAG that has been validated, or confirmed to be correct. In step 511, the candidates are fed back into the rule engine 402, which filters and consolidates the results. Finally, in step 512, the system displays a web page with the results formatted as depicted in FIG. 3.

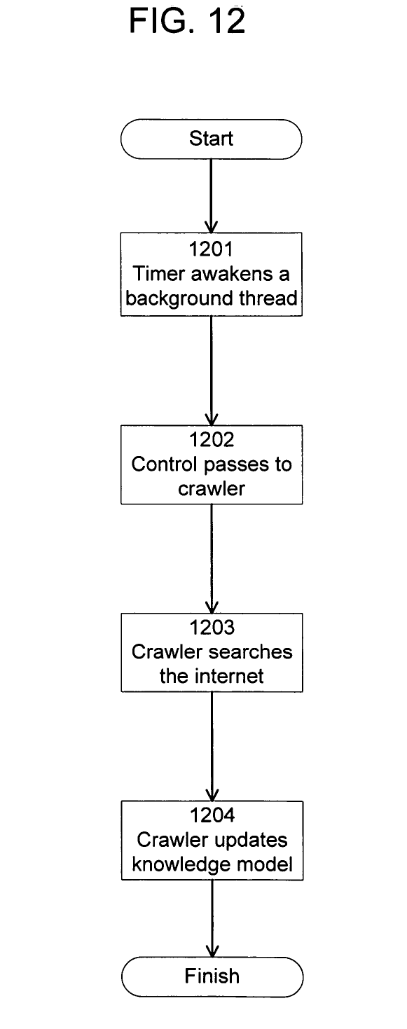

In some examples, a number of tasks are running asynchronously in the background. FIG. 12 describes these tasks. In advance, the knowledge module 401 is preconfigured to include information about common product categories (e.g., dishwashers) and manufacturers (e.g., Kenmore). Execution of one background task begins in step 1201 when a timer awakens a background thread. In step 1202, control passes to the crawler 403. The crawler 403 searches the internet, using a search engine such as www.google.com, for web pages relating to each of the categories and manufacturers in the knowledge model 401 (step 1203). In step 1204, the crawler 403 updates the knowledge model 401 with results gleaned from the search results.

In some examples, a second background task causes the periodic operation of the learning module 405, whose operation is explained below.

Other embodiments may include additional modules, omit these described modules, or consist of entirely different modules.

A. The Knowledge Module

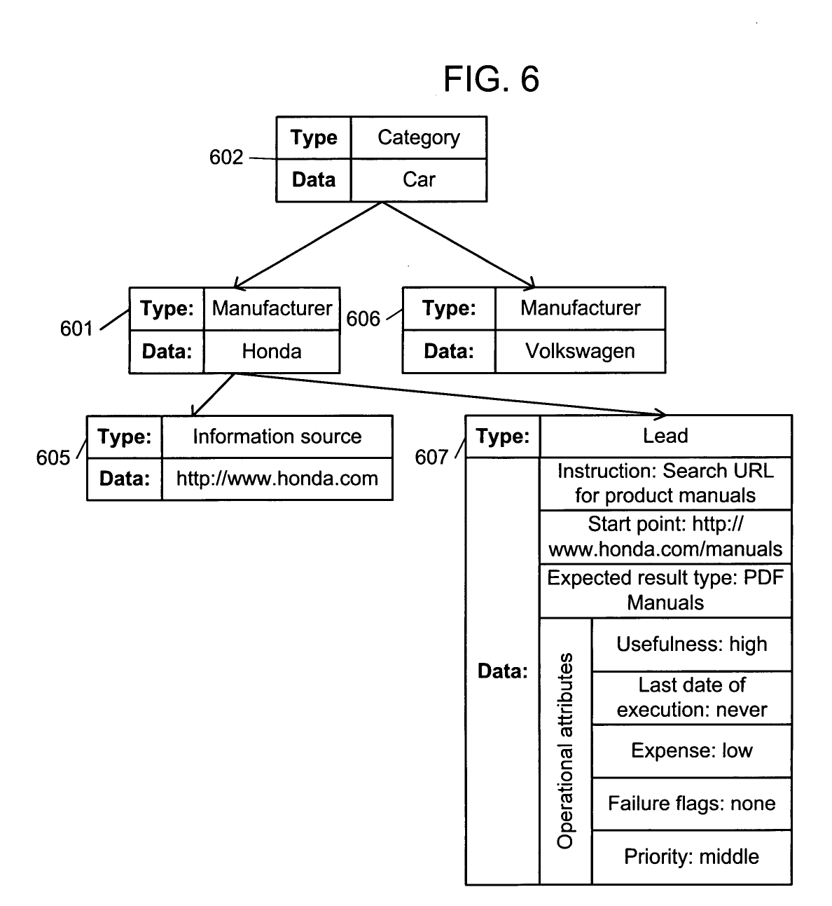

Some embodiments include a knowledge module 401. The knowledge module maintains a knowledge model, an example of which is depicted in FIG. 6. The knowledge model is an object-oriented semantic network. Each node in the network represents an entity tracked by the system. Each entity is a member of one or more classes. In some examples, one type of object class tracked by the knowledge model 401 is called a category. Category objects are hierarchically-linked in the knowledge model 401 to form an ontology. For example, the following category nodes might be linked: Appliances/Home appliances/Kitchen/Dishwashers.

In some examples, the knowledge module 401 tracks entities (nodes) including product manufacturers (e.g., Honda, Sony, or Panasonic); categories (e.g,. flat-screen televisions or automobiles); information sources (e.g., web sites, phone numbers, or static documents); resources found (e.g., retrieved and derived facts, URLs, or documents); rules (used by the rule engine 402); and leads (used by the crawler 403).

Links between nodes in the knowledge module represent relationships and are directional. The nature of the relationship depends on the type of node. For example, with reference to FIG. 6, the link to the “Honda” node 601 (of type “manufacturer”) from the “car” node 602 (of type “category”) indicates that a Honda is a type of car. The link from the “Honda” node 601 to the “web site” node 605 (of type “information source”) indicates that Honda has a web site at the given URL. The knowledge model of FIG. 6 also knows that “Volkswagen” (node 606) is another manufacturer of cars (node 602).

B. The Rule Engine

Some embodiments include a rule engine 402. The rule engine takes an input, applies relevant rules to it, and delivers an output. It includes meta-rules used to govern the order in which rules are applied.

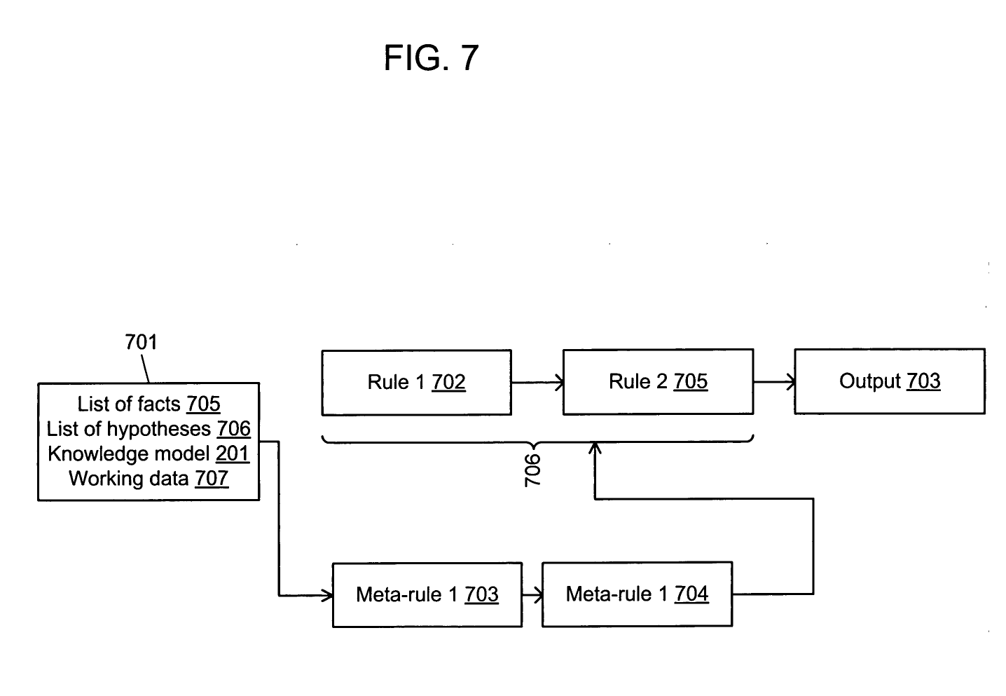

In some embodiments, the rule engine 402 is structured as depicted in FIG.7. The engine 402 takes an input 701 and transforms it in a manner specified by a series of applicable rules 702, 705 to create the desired output 703. In some examples, rules are linked such that the output of one rule 702 becomes the input of the next rule 705. Rules are linked together in a rule queue 706.

In some embodiments, rules are selected and ordered through the operation of one or more meta-rules 703, 704.

1. Input

In some examples, the input 701 is a data structure representing partial knowledge, i.e., what is known so far. In some examples, the input consists of a list of facts 705 that are assumed to be true, plus a list of hypotheses 706 which are likely to be true. In some examples, the input includes a reference to a knowledge module 401. In some examples, the input also includes working data 707, including the user's search term and intermediate results accumulated so far.

2. Types of Rules

A rule transforms the input to result in the output. For example, a rule might copy some or all of an input into the output. A rule might modify or rewrite the input to produce the output. A rule might also log certain types of events for later examination by a human. Each rule has at least one trigger, indicating the circumstances under which it is to execute. It also has at least one consequence, indicating the transformation to be applied.

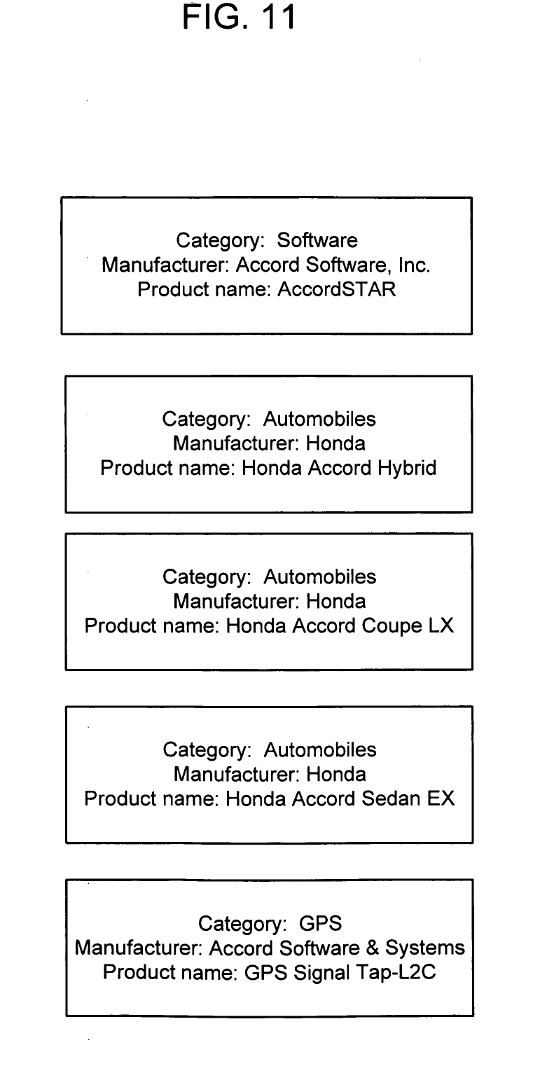

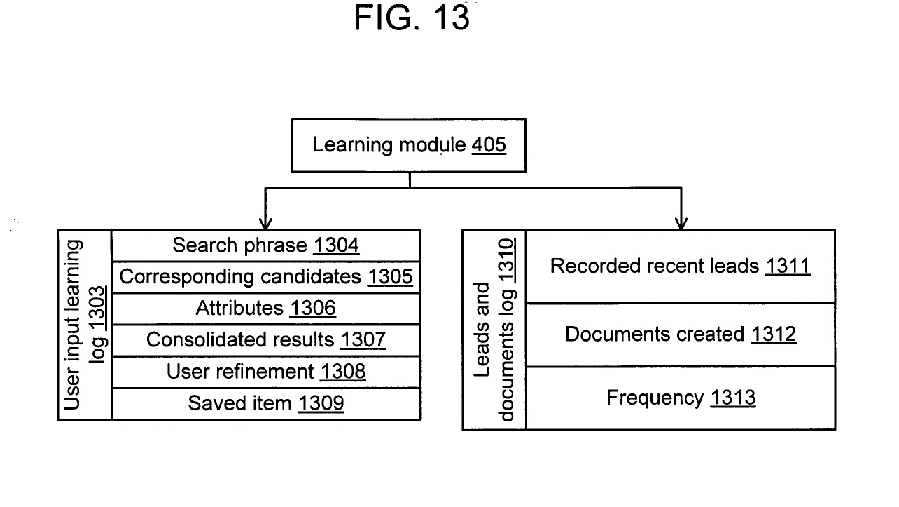

In some examples, there are at least three kinds of rules. The first kind has a trigger that matches a search string entered by a user. This type of rule outputs a data structure known as a Core Attribute Guess, or CAG. A CAG is a data structure representing a likely manufacturer, category, and/or product name relating to the search phrase. FIG. 11 depicts five possible CAGs that might be generated by the rule engine 402 based on the search term “Accord.” This type of rule applies a heuristic to a set of web results generated by the crawler 403 (FIG. 13, step 1310). For example, the rule might generate a CAG for a Honda Accord Hybrid because, after analyzing the web results, the rule concludes that Accord Hybrid often occurs in close proximity to Honda, which already has a node in the knowledge model 401 indicating that Honda is an automobile manufacturer.

A second type of rule takes as input a list of CAGs. This type of rule searches the knowledge model 401 for leads associated with each CAG. For each associated lead, this type of rule executes the instruction contained in the lead, and attempts to verify the CAG, that is, verify that the manufacturer referenced in the CAG in fact manufactures the referenced product. For example, in the knowledge model 401, one lead is a link to a page on Honda's web site containing a list of all its current automobiles. The rule verifying this CAG retrieves this page from the Honda web site and searches for the product name contained in the CAG (i.e., “Honda Accord Hybrid”) to verify that this string in fact occurs on this page.

A third kind of rule takes the list of candidates and filters and consolidates candidates to yield a final list of results. Some of the generated candidates may be duplicative (for example, if a given product name has multiple alternative spelling). Others may be inconsistent (for example, if there are five results for types of Honda Accords, and one result for computer software); in this case, the rule may decide that the user was probably searching for a car and not for software, and might eliminate the software result. (Some rules would not eliminate the inconsistent result, and provide that alternative result to the user in addition to all the models of the Honda Accord.)

3. Meta-Rules

A meta-rule is a special rule that operates on the rule queue. Meta-rules are the same as rules, except that instead of transforming input into output, they operate on the rule queue 706. Meta-rules may add, remove, or reorder rules to be applied. Some examples of meta-rules operate based on an analysis of the input. Others adjust the relative weight given a particular rule based on the rule's history of providing relevant results.

4. Execution

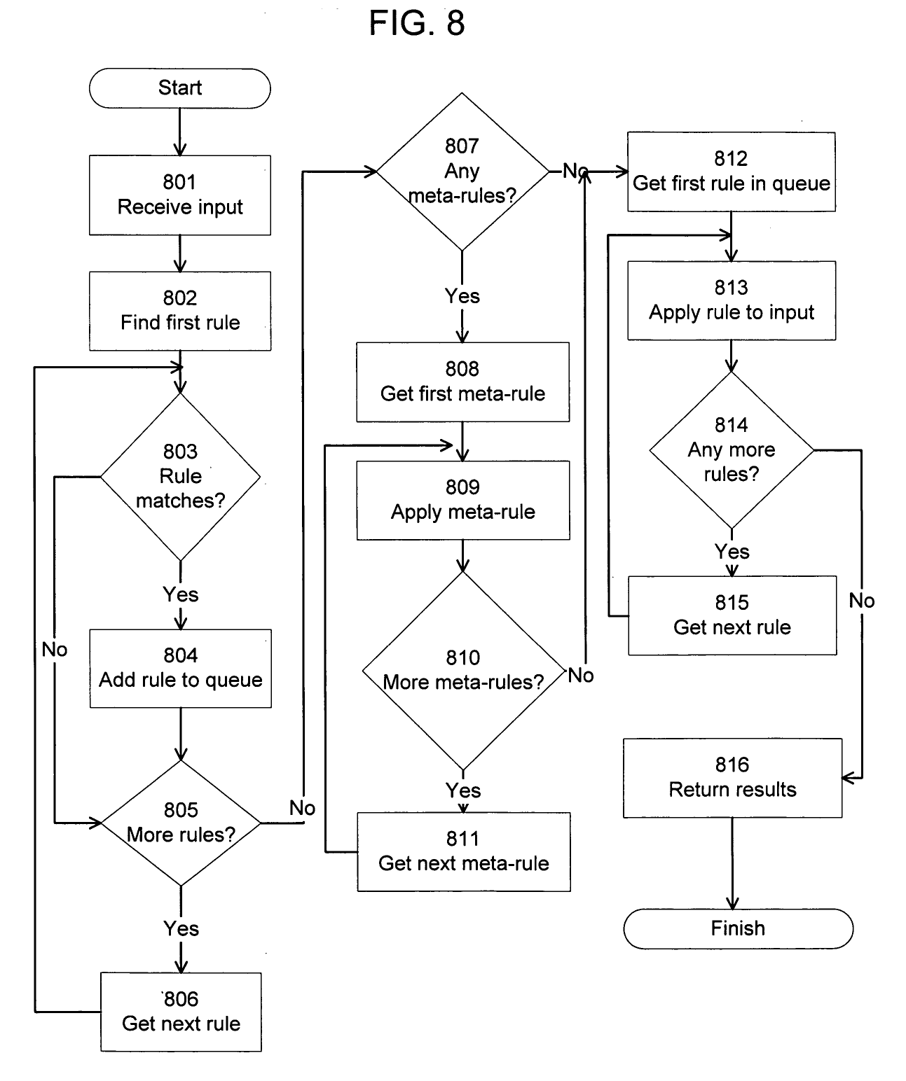

FIG. 8 describes the manner in which the rule engine 402 operates in one embodiment. In step 801, the engine receives the input. In steps 802-806, the engine makes a queue of rules matching the current input. In step 802, the engine finds the first available rule. In step 803, it checks to see if the rule has a trigger matching the current input. If not, the process skips to step 805. Otherwise, in step 804, the engine adds the rule to the queue. In step 805, the engine checks to see if there are more rules available. If so, then in step 806, the engine fetches the next rule, and returns to step 802.

When each of the rules have been stepped through, in step 807, the engine checks to see if any meta-rules are available If there are, then in step 808, then engine fetches the first meta-rule. In step 809, the engine applies the meta-rule to reorder the rules in the queue. In step 810, the engine checks to see if any more meta-rules are available. If there are, then in step 811, the engine fetches the next meta-rule, and returns to step 809.

Otherwise, in step 812, the engine fetches the first rule in the queue. In step 813, it applies the rule to the input—passing to the rule both the user's original input and any results generated by other rules already executed. The rule adds its own results to the list of intermediate results passed in. Then, in step 814, the engine checks to see if there are any more rules. If so, in step 815, the engine fetches the next rule, and returns to step 813. If not, then in step 816, the engine returns the combined results of the rules.

C. Leads

1. Representation

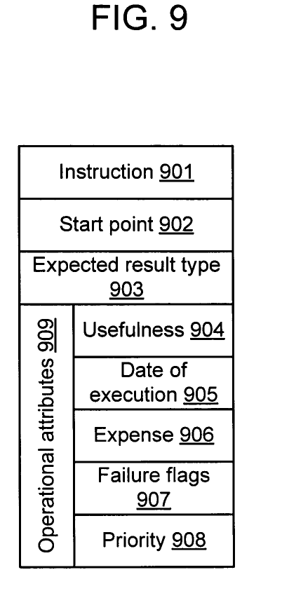

FIG. 9 depicts the representation of leads 404 in some embodiments. A lead is a data structure representing a promising potential source of information. In some examples, the data structure includes information representing an instruction 901; the start point 902; the expected result type 903; and operational attributes 909. Operational attributes 909 include the usefulness of the lead 904; the date of most recent execution 905; the expense of the lead 906 (in terms of time or other resources); failure flags 907 (in case URL is unresponsive or raises errors); and priority 908.

In some examples, the instruction 901 is a constant representing one of the following instructions:
Search a given URL (specified in the start point 902) to find out about a given manufacturer
Search a given URL (specified in the start point 902) to find out about a given product
Search a given URL (specified in the start point 902) to get a useful list of categories
Search a given URL (specified in the start point 902) to get repair manuals for a given product
Use a search box on a web site (specified in the start point 902) to conduct a search
Click at a given set of coordinates in a navigation bar to get support information for a given manufacturer

In some examples, a lead contains an instruction to compose a search query to be delegated to an external search engine on the internet, then to gather the results from the external search engine.

As depicted in FIG. 6, in some embodiments, the knowledge module 401 tracks information about leads. For example, a link from the “Honda” node 601 to the “Honda leads” node 607 indicates that the given lead 406 provides product manuals for Honda vehicles.

D. Crawler

In some examples, the crawler 403 is responsible for periodically gathering up all relevant leads to run, and executing them. The crawler 403 executes leads with higher priority 908 more frequently than leads with lower priority. When the crawler 403 executes a lead, it performs a query specified by the instruction 901 contained in the lead. After performing the query, it records the operational attributes of the query in the operational attributes 909 section of the lead. It then records the results of the query by adding “resources found” nodes to the knowledge module 401. The crawler can also operate in conjunction with the rule engine 402 to update arbitrary nodes in the knowledge module 401. In one example, the crawler may discover new categories, using heuristics set forth in a set of rules, and update the knowledge module 401 with information about the new categories. In other examples, instead of using the rule engine 402, these heuristics are hard-coded in the crawler 403.

E. Query Engine

In some examples, the query engine 404 handles requests from users. Requests may be either interactive or stored. In an interactive request, a user enters a search phrase in real time. A stored request consists of previously-saved interactive requests.

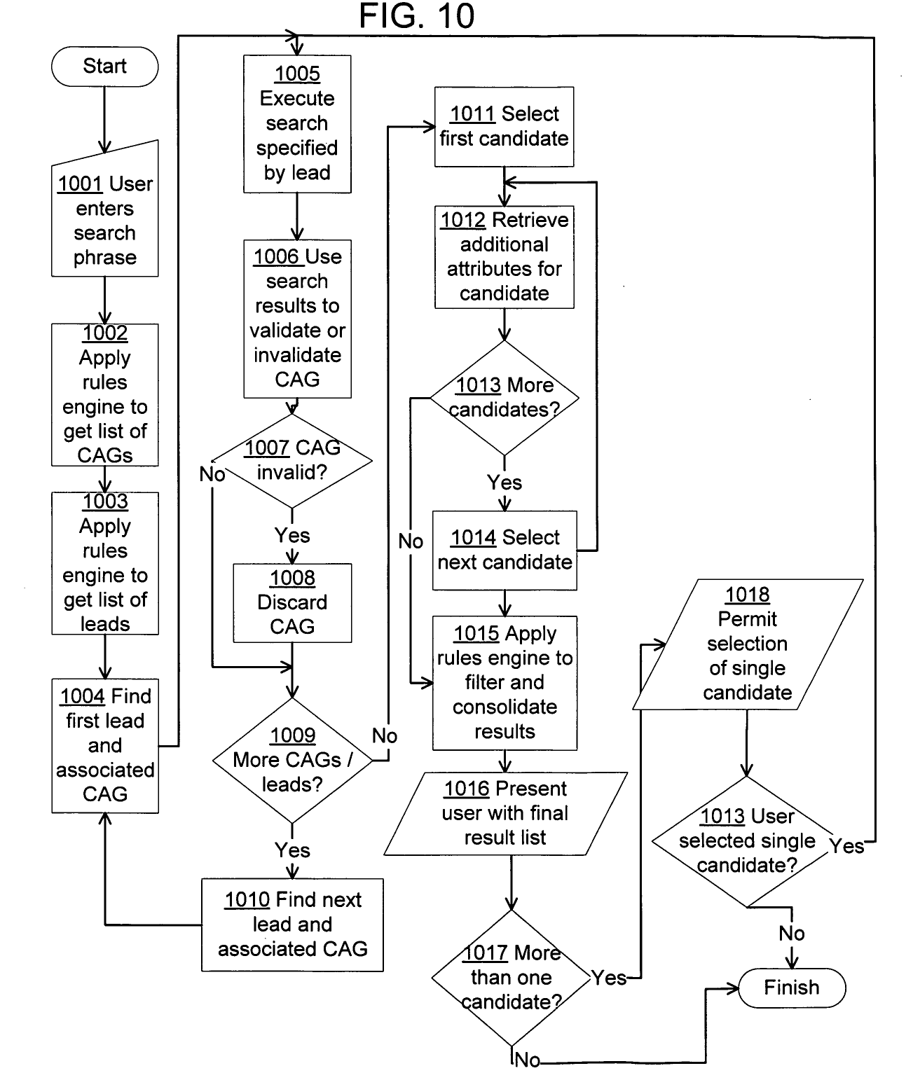

FIG. 10 depicts the process by which, in some examples, the query engine 404 handles an interactive request. In step 1001, the user enters a search phrase. In step 1002, the rule engine 402 is applied to the search phrase (see FIG. 8). The rule engine 402 outputs a list of CAGs.

In step 1003, the CAGs are passed back into the rule engine 402, which outputs a list of leads. These leads describe relevant web searches that can be used to validate the CAGs.

In step 1005, the query engine 404 executes the search specified by each of the generated leads. In step 1006, the query engine determines which CAGs have been validated and which have not, discarding the invalidated CAGs (step 1008). The validated CAGs are called candidates. In step 1009, the query engine examines each candidate and retrieves additional attributes such as a photograph of the product; the product description; repair information; documents (such as user manuals, installation manuals, and brochures); and links to reviews and support web pages. In some examples, the query engine uses leads associated with each candidate to retrieve this information. In some examples, the query engine 404 uses the rule engine 402, either instead of or in conjunction with the leads.

In step 1015, the query engine 404 invokes the rule engine 402 again to filter and consolidate the results, as described above in connection with the rule engine 402.

In step 1016, the results are presented to the user on a web page. If there are multiple candidates, the web page provides the user with the option of refining or modifying the search by making a selection from among the candidates. If the user elects to refine the search (step 1013), control returns to step 1005, which executes the newly-refined search.

In some examples, the web page also gives the user the option to save the current search. If the user selects this option, some embodiments save the search in an XML file in a location personalized to the user, such as on the user's home computer or on a network storage area.

As described earlier, FIGS. 3B and 3C depicts an example interactive web page. This interface allows a user to browse and continue to refine the information in the stored requests. Additional information, such as serial numbers or maintenance records, can be added to objects stored in the XML file, through this interactive area. In another embodiment, this additional information can be retrieved directly from a manufacturer's web site or another external source.

F. Learning Module

As depicted in FIG. 13, in some examples, the learning module 405 is used to accumulate knowledge from use of the system and improve its accuracy and effectiveness. The learning module 405 maintains a series of logs and rules which look over those logs for opportunities to improve accuracy.

In some embodiments, the learning module 405 maintains a user input learning log 1303 which accumulates samples of user inputs. Referring to FIGS. 10 and 13, the user input learning log 1303 stores the user's search phrase 1304 (step 1005 of FIG. 10), corresponding candidates 1305 ascertained in step 1006, attributes 1306 retrieved in step 1009, consolidated results 1307 derived in step 1015, any user refinement 1308 (step 1013), and the final saved item 1309.

In some embodiments, the learning module 405 maintains a leads and documents log 1310. In this log is recorded recent leads 1311, results created by these leads 1312, and the frequency 1313 with which these results are referred to by users. In some embodiment, the rule engine 402 contains a rule that refers to the leads and documents log 1310 to display the results of more popular leads more prominently than the results of less popular leads. In addition, a system administrator may review the leads and documents log 1310 manually, to gain insight into which leads are most productive. A system administrator may also use this information to write better rules; for example, if the leads and documents log 1310 shows that most people who search for “iPod” are searching for an Apple iPod, the system administrator can write a rule to more heavily weight Apple iPods in the search results. A system administrator may also discover a number of searches for “i-Pod” executed by individuals searching for iPods. The administrator could then write a rule in which searches for “i-Pod” are modified to search for “iPod.”

A system administrator could also write a rule that implements a misspelling subsystem. Such a rule might automatically remove hyphens from search terms, change vowels, and correct common spelling mistakes.

Some examples of the learning modules modify the knowledge module 401. For example, a learning module can update a manufacturer node, adding a “known products” attribute, that a rule in the rule engine 402 may refer to when creating or validating CAGs. In another example, a learning module updates the “coffeemaker” category node, adding a “popular manufacturers” attribute including the data “Braun,” to suggest to a rule that Braun products might be heavily weighted in search results.

G. Storage

Some embodiments include a storage area. The storage area is where data for the above systems is stored. Some examples use text files for storage. Some examples use a SQL database, such as MySQL, for storage. Some examples permit the storage to be accessed from the internet.

Some embodiments use a user's local hard drive for certain types of personal storage, such as users' stored requests. Other embodiments use an independent high-capacity network storage location for personal storage.

In some examples, personal user information is stored in a distributed manner, i.e., not on the server executing the system described. In some examples, the personal user information is stored on a user's own hard disk.

H. Administration

Some embodiments include an administration area that provides tools for managing the system's operations. In some examples, these tools include utilities for authoring and editing content, such as the knowledge model and the rules. Other tools include reporting tools to allow an administrator to review usage patterns and to assist an administrator in resource planning.

Although a particular embodiment has been described, other embodiments are within the scope of the following claims. For example, except where specifically indicated in the claim language, the claims are not necessarily limited to operation over the internet. The claims are not restricted to using the specific components or user interfaces described above. The claims are not necessarily limited to tracking information about physical products. Rather, the scope of the invention is defined solely by the claim language.

What is claimed is:

1. A method comprising:
receiving an electronic query of a user directed to obtaining items of information belonging to one or more predefined categories and that relate to an interest of the user in a specified product;
searching in a plurality of locations; and
presenting to the user essentially only items of information that relate to the interest of the user and that belong to the categories, the items not being limited to a price and a source for the product and not being limited to items that have been pre-arranged for presentation to the user in reply to an online query that refers to the product.

2. The method of claim 1, wherein the plurality of locations includes a database.

3. The method of claim 1, wherein the plurality of locations includes a web site.

4. The method of claim 1, wherein the plurality of locations includes two locations on the internet, the two locations on the internet being owned by different entities.

5. The method of claim 1, wherein the interest of the user in the product comprises an ownership interest.

6. The method of claim 1, wherein one of the categories comprises information relevant to maintaining the product.

7. The method of claim 1, wherein one of the categories comprises product manuals.

8. The method of claim 1, wherein one of the categories comprises web sites.

9. The method of claim 8, wherein the web sites belong to the product manufacturer.

10. The method of claim 1, wherein one of the categories comprises a resale value.

11. The method of claim 1, further comprising storing the items of information.

12. The method of claim 1 1, wherein the items of information are stored in a location under the user's control.

13. The method of claim 1, further comprising:
receiving other information about the product from the user; and
associating the items of information with the other information.

14. The method of claim 1, further comprising:
presenting to the user an option to sell the specified product.

15. The method of claim 13, wherein the other information comprises a serial number.

16. The method of claim 13, wherein the other information comprises a purchase date.

17. The method of claim 13, wherein the other information comprises a proof of purchase.

18. The method of claim 1, further comprising:
receiving other information about the product from a retailer; and
associating the items of information with the other information.

19. A method comprising:
at the request of a user who has a interest in a product, electronically searching for first information that is associated with the product and is relevant to the property interest,
receiving results of the search, at least two results being received from different sources,
receiving additional information from the user about the product;
associating the additional information with the first information; and
storing the additional information.

20. The method of claim 19, wherein the interest is a property interest.

21. The method of claim 19, wherein the step of electronic searching is performed on the internet.

22. The method of claim 19, wherein the first information is relevant to maintaining the product.

23. The method of claim 19, wherein the additional information comprises a serial number.

24. The method of claim 19, wherein the additional information is stored in a location controlled by the user.
